(19) United States
(12) Patent Application Publication
(10) Pub. No.: US 2009/0161041 A1
(43) Pub. Date: Jun. 25, 2009

(54) LIGHT SOURCE DEVICE AND LIQUID CRYSTAL DISPLAY DEVICE

(75) Inventors: Kiyoshi Hashimotodani, Osaka (JP); Masaki Hirohashi, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 12/095,351

(22) PCT Filed: Nov. 14, 2007
(86) PCT No.: PCT/JP2007/072103

§ 371 Date: May 29, 2008

(30) Foreign Application Priority Data
Nov. 16, 2006 (JP) 2006-310267

(51) Int. Cl. G02F 1/13357; H01J 61/78

(52) U.S. Cl. 349/69; 313/491

(57) ABSTRACT

A light source device includes a plurality of juxtaposed discharge tubes, each of which includes an internal electrode at least at one end, is made of transmissive material, has a phosphor layer formed at the inner side of the discharge tube, and is filled with a discharge gas containing xenon, an external electrode which is conductive and flat-shaped, is spaced from the plurality of discharge tubes by a specific distance, and is connected electrically to the grounding potential, and a conductive member electrically configured to connect the outer surface of all of the plurality of discharge tubes to the external electrode.

### TECHNICAL FIELD

The present invention relates to a discharge light source using dielectric barrier discharge, and a liquid crystal display device using such a light source.

### BACKGROUND ART

Recently, as the digital television is becoming wider in screen and smaller in thickness, there is an increasing demand for larger size of liquid crystal display backlight. As the light source for liquid crystal display backlight, the conventional cold cathode fluorescent lamp is being replaced by solid light-emitting device such as light-emitting diode or organic EL element, and commercial products are partly developed. However, for the time being, the cold cathode fluorescent lamp may not be completely replaced in view of the viewpoints of efficiency of light emission, service life, and cost.

The fluorescent lamp uses a low-pressure glow discharge including mercury which is an environmental load, as an ultraviolet source for exciting phosphor as light-emitting material. In view of environmental protection, it is being desired to develop a light source having light emission efficiency equal to that of the existing fluorescent lamp without using mercury.

To achieve the purpose, it is required to develop a radiation source capable of emitting efficiently ultraviolet with wavelength (about 100 to 300 nm) enough to excite phosphors to radiate light effectively. Noticeable ultraviolet radiation medium other than mercury, which radiates ultraviolet by discharge, is a discharge plasma at low to medium pressure (about less than atmospheric pressure), which is mainly composed of rare gases. One photon of ultraviolet emission is finally converted to one photon of visible light by a phosphor, and the energy corresponding to the difference between ultraviolet emission energy and visible light energy makes loss. Hence, the wavelength of ultraviolet emission caused by discharge is preferred to be closer to that of visible light. Accordingly, among rare gas discharges, especially the discharge plasma which is mainly composed of xenon is considered useful since the wavelength of the radiated ultraviolet emission is relatively longer.

In xenon discharge, in particular, it is known that broad radiation efficiency is high around 172 nm, radiated upon dissociation of excimer (excited dimer) which is unstably bond xenon atoms in excited state and in ground state. Generally, generation, radiation, and dissociation of excimer are particularly high in efficiency in pulse after-glow. Accordingly, as compared with ordinary glow discharge, a higher efficiency is expected in the so-called dielectric barrier discharge having a dielectric layer serving as a charge barrier for cutting off current flow between the electrode and discharge space.

Therefore, regarding rare gas fluorescent lamps which using rare gas discharge caused by mainly xenon, particularly, one having a structure which uses glass tube wall of the discharge tube as dielectric layer of charge barrier has been intensively studied.

However, in the structure of using the discharge tube wall as the charge barrier, external electrodes must be disposed outside of the discharge tube. When ordinary metal electrodes are used as external electrodes, a possible problem is effect of external electrodes on light distribution characteristics. In particular, in application of a backlight for a large screen liquid crystal display television, generally, a plurality of lamps are laid in parallel under the liquid crystal display panel, and diffusion and reflection panels are disposed beneath them. In a television screen, uniformity in luminance distribution is particularly important, and a special attention must be paid to structure and layout of external electrodes. As an example of such structure, a lamp device disclosed in patent document 1 is shown in FIG. 8.

FIG. 8 is a diagram of backlight device composed of a plurality of rare gas fluorescent lamps by dielectric barrier discharge.

In FIG. 8, a discharge tube 1 is a sealed container of which inside functions as a discharge space and which is made of hard glass filled with a discharge medium. A plurality of discharge tubes 1 disposed in parallel (two tubes shown in FIG. 8 as representative) function as a backlight device. Each discharge tube 1 is provided with one internal electrode 2 at an end thereof. A flat grounded external electrode 3 which is commonly provided to discharge tubes 1 is spaced from each discharge tube 1 with a predetermined gap. A common lighting circuit is connected between each internal electrode 2 and external electrode 3, applying a high-frequency voltage.

This configuration allows a dielectric barrier discharge using the tube wall of the discharge tube 1 as the charge barrier to occur between the internal electrode 2 and external electrode 3, and thus a rare gas fluorescent lamp having high efficiency can be realized with the same optical structure as a general cold cathode fluorescent light lamp backlight unit containing mercury.

In the configuration shown in FIG. 8, the discharge tube 1 and external electrode 3 compose a capacitive load as seen from the lighting circuit. Since the capacitive load limits the current, it does not need to provide the lighting circuit independently for each discharge tube 1, allowing the cost to be saved substantially.

Patent Document 1: WO2005/022586 (see FIG. 18)

### DISCLOSURE OF INVENTION

### Problems to be Solved by the Invention

The inventors of the present invention have tested the configuration disclosed in patent document 1 as shown in FIG. 8, and discovered that the luminance of the individual discharge tubes may not be always uniform in spite of uniform driving voltage applied to the internal electrodes, in particular, when more than five discharge tubes are disposed in parallel on the common external electrode. For example, the luminance of the individual discharge tubes 1 was measured with twelve discharge tubes spaced from each other in parallel at a interval of 21 mm and placed with a gap of 3 mm from the external electrode 3, obtaining the measuring results as shown in FIG. 9. As shown in the figure, a phenomenon can be observed occasionally, in which bright discharge tube 1 and dark discharge tube 1 appear alternately. Such bright-dark pattern appears alternately in the sequence of discharge tubes when a plurality of discharge tubes 1 are spaced from each other at precisely equal interval. However, if the precision of interval between the discharge tubes is poor, the bright-dark pattern does not always appear alternately in the sequence of the discharge tubes, but such pattern happens to appear periodically. The difference in luminance between bright discharge tube and dark discharge tube appearing alternately was more significant in particular in the portion far from the internal electrode 2. Since the external electrode 3 is grounded at an equal distance from each discharge tube 1, and the voltage input wire to the internal electrodes 2 is commonly connected and is at the same potential, it is estimated that the currents in the discharge tubes 1 were not uniform due to a certain cause.

In the conventional configuration, from the viewpoint of generation of corona discharge or efficiency of light emission, a gap is provided between the discharge tube 1 and external electrode 3. If the discharge tube 1 is directly contacted the external electrode 3 without a gap, the outer surface of the discharge tube 1 is firmly fixed to the potential (grounding potential) of the external electrode 3, and thus the discharge tube 1 does not have effects of external electric field. On the other hand, when a gap is provided, the discharge tube 1 is likely to be affected by external electric field. In particular, when a plurality of discharge tubes are disposed in parallel, it is considered that such bright-dark pattern is likely to appear.

As mentioned above, uniformity of luminance is important to the liquid crystal display backlight for television, and such bright-dark pattern is not desired. Although correction with optical sheet at the front side is possible, it brings about more demerits, such as increase of cost due to use of diffusion sheet, and drop of light output efficiency.

The invention is directed to solve the above mentioned problems, and has an object to present a light source device including a plurality of juxtaposed rare gas fluorescent lamps for dielectric barrier discharge, capable of making luminance of discharge tubes uniform.

### Solving Means

A light source device according to the invention includes: a plurality of juxtaposed discharge tubes, each of which includes an internal electrode at least at one end, is made of transmissive (transparent) material, has a phosphor layer formed at the inner side of the discharge tube, and is filled with a discharge gas containing xenon; an external electrode which is conductive and flat-shaped, is spaced from the plurality of discharge tubes by a specific distance, and is connected electrically to the grounding potential; and a conductive member electrically connecting the outer surface of all of the plurality of discharge tubes to the external electrode.

Preferably, the conductive member may be a band-shaped metal foil disposed orthogonally to the discharge tube. As a result, light shielding by the conductive member may be reduced.

Preferably, the conductive member may be disposed at a distance more than half of the overall length of the discharge tube from the internal electrode of the discharge tubes. Further a greater effect can be obtained when the conductive member is disposed at a distance equal to a length more than 60 percent to less than 80 percent of the overall length of the discharge tube from the internal electrode of the discharge tubes.

The conductive member may be disposed between the discharge tube and the external electrode. Alternatively, the conductive member may be disposed on the opposite side of the discharge tube to the surface of the discharge tube on the external electrode side.

A liquid crystal display device according to the invention, includes a liquid crystal display panel, and a backlight device for illuminating the liquid crystal display panel, including the light source device described above.

### EFFECTS OF THE INVENTION

The invention has a conductive member disposed at a specified position outside discharge tubes to suppresses fluctuations of luminance of juxtaposed individual discharge tubes, and thus can provide a rare gas fluorescent lamp backlight device achieving high uniformity on screen.

### BRIEF DESCRIPTION OF DRAWINGS

FIG. 1 is a diagram showing a configuration of a liquid crystal display backlight device in a first embodiment of the invention.

FIG. 2 is a sectional view of a liquid crystal display backlight device in the first embodiment of the invention.

FIG. 3 is a graph explaining the effects of the liquid crystal display backlight device in the first embodiment of the invention.

FIG. 4 is a diagram showing operating principle of the rare gas fluorescent lamp of the invention.

FIG. 5 is a graph explaining an appropriate position of a conductive member.

FIG. 6 is a diagram showing a configuration of a liquid crystal display backlight device in a second embodiment of the invention.

FIG. 7 is a diagram showing a configuration of a liquid crystal display device in a third embodiment of the invention.

FIG. 8 is a diagram showing a configuration of a rare gas fluorescent lamp in a prior art.

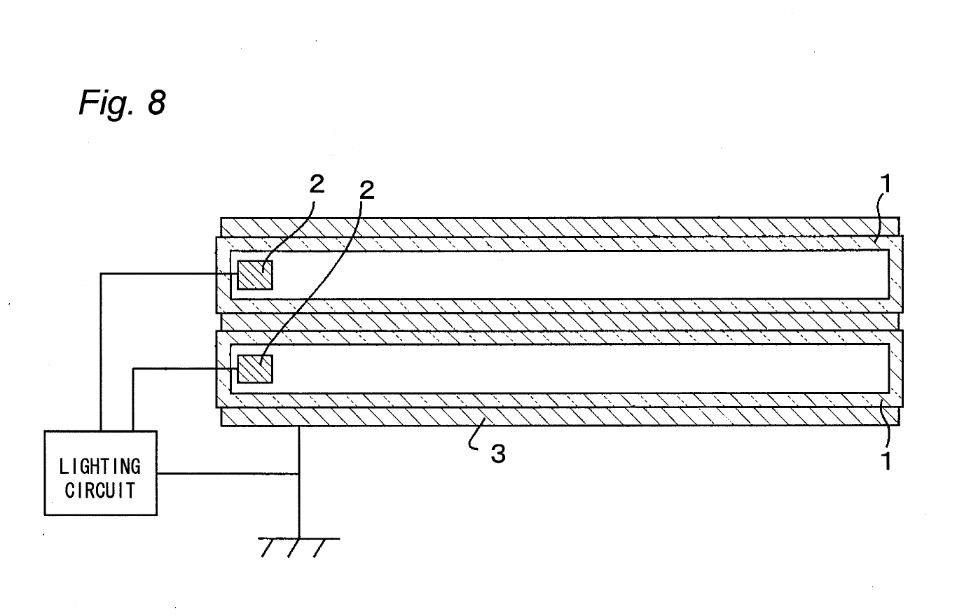

FIG. 9 is a graph explaining the problems in the rare gas fluorescent lamp in a prior art.

### REFERENCE NUMERALS

1, 101 Discharge tube
2, 102 Internal electrode
3, 103 External electrode
104 Spacer
105 Conductive member
106 Conductive member operating as internal charge adjusting element
107 Connector
108 Power line
109 Power supply circuit (lighting circuit)
110 Diffusion optical member
111 Opening in diffusion optical member

### BEST MODE FOR CARRYING OUT THE INVENTION

Preferred embodiments of the invention are described below with reference to the accompanying drawings.

### First Embodiment

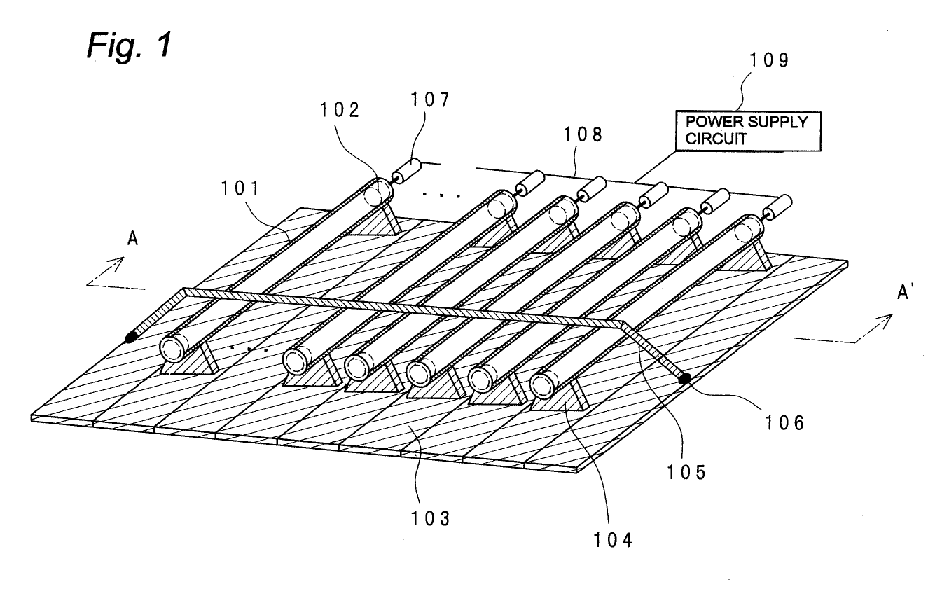

FIG. 1 is a diagram showing a configuration of a liquid crystal display backlight device (light source device) using rare gas fluorescent lamps in the first embodiment of the invention.

In the liquid crystal display backlight device 10 shown in FIG. 1, a discharge tube 101 is a cylindrical tube of hard glass having light transparency (being transmissive) such as borosilicate glass, and its inner surface is provided with phosphor layer (not shown) of three wavelengths selected so that the excitation spectrum may be particularly strong in vacuum ultraviolet region (mainly 200 nm or less). In the present embodiment, the discharge tube 101 has a length of is 370 mm (length between ends of the glass tube) and an inside radius of 1.5 mm. A total of twelve discharge tubes 101 are juxtaposed at interval of 21 mm (distance between central axes of discharge tubes 101). FIG. 1 shows only six discharge tubes 101 as representative examples. The discharge tubes 101 is filled with discharge gas, which is, a rare gas mainly composed of xenon at pressure of 120 Torr at ordinary temperature. At the end of one side of the discharge tube 101, the internal electrode 101 which is a cup-shaped cold cathode made of metal having high melting point and high electric conductivity such as nickel is provided hermetically inside the discharge tube 102. The discharge tube 101 is held at a position of distance of 5.0 mm from a flat-shaped external electrode 103 made of aluminum material having the surface treated with high luminance reflection coating, by spacers 104 made of insulating member such as silicone resin. The distance between the discharge tube 101 and external electrode 103 is the shortest distance between the outer surface of discharge tube 101 and the external electrode 103. If the shortest distance varies in each discharge tube, the shortest one among the shortest distances is selected.

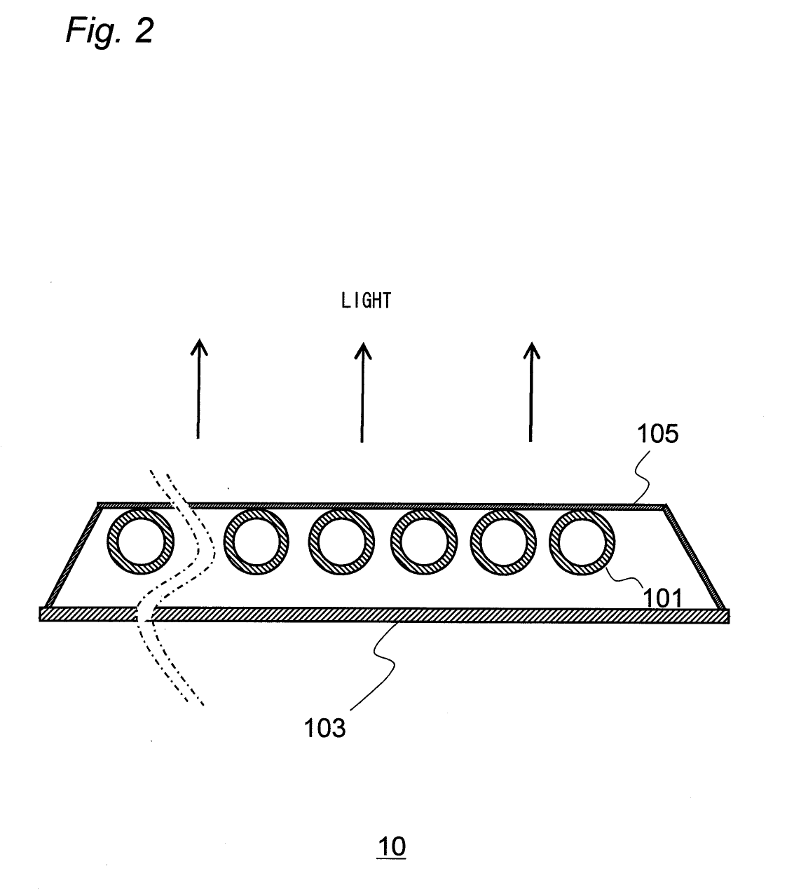

FIG. 2 is a sectional view of liquid crystal display backlight device 10 in FIG. 1 cut along line A-A′. As shown in the figure, the conductive member 105 is disposed in the upper part of the discharge tube 101, and is connected to the external electrode 103. The external electrode 103 is provided on a flat plane parallel to the central axis of at least one discharge tube 101.

A drive voltage of 20 kHz, 2.0 kV₀₋ₚ is applied to the discharge tube 101 from a power supply circuit (lighting circuit) 109. When a voltage is applied, the glass tube wall of the discharge tube 101 acts as a charge barrier, realizing a dielectric barrier discharge between the internal electrode 102 and external electrode 103.

The “flat shape” of the external electrode 103 does not always mean to be a perfectly flat. For example, it allows a shape having a width larger than the diameter of the discharge tube 101 and a carved shape with a radius of curvature larger than the distance to the axis of the discharge tube 101.

When the dielectric barrier discharge is utilized such as in the rare gas fluorescent lamp of the present embodiment, the load of the entire lamp as seen from the power supply circuit is capacitive. Therefore, the current flowing in each lamp is limited by the load capacity, and unlikely the conventional cold cathode lamp which shows a negative characteristic in current and voltage, the rare gas fluorescent lamp of the present embodiment is capable of lighting a plurality of lamps with a single power supply circuit. Accordingly, in the preferred embodiment, the internal electrode 102 is connected to a common power source line 108 through a connector 107 and is driven by a single power supply circuit 109.

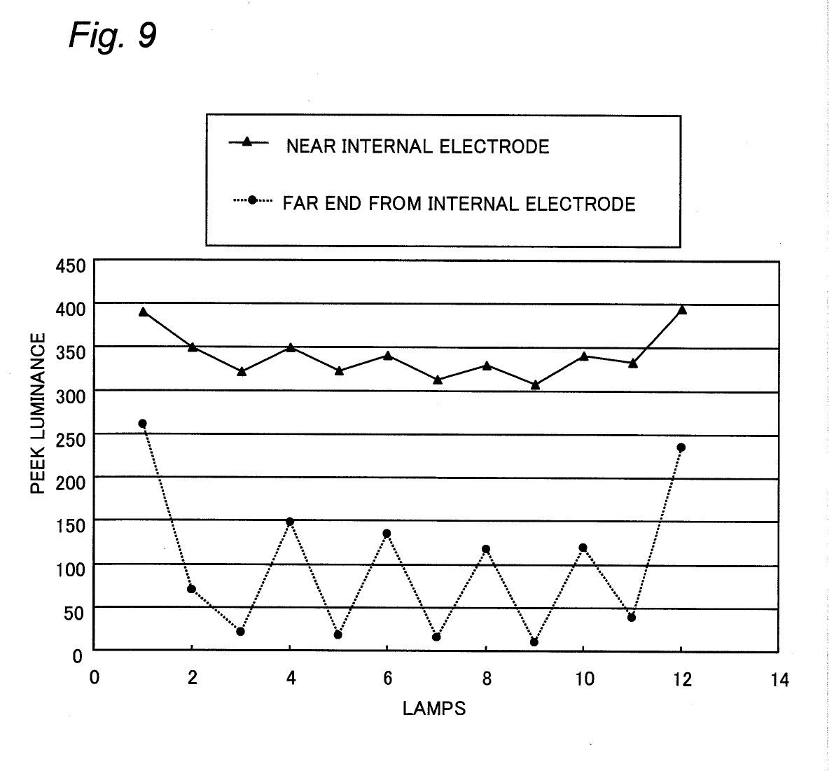

As described before, there is a following problem in the backlight device composed of a plurality of juxtaposed discharge tubes 101 for the common external electrode 103 and the power supply circuit 109. Although the voltages applied to the internal electrodes 102 are common and equal, the luminance of the individual discharge tubes 101 is not uniform, and bright and dark tubes appear alternately. This problem becomes particularly significant when the distance from the internal electrodes 102 becomes longer as shown in FIG. 9.

For the problem, the inventors has attempted to provide the conductive member 105 as shown in FIG. 1 on the outer surface of the discharge tubes 101, and discovered that fluctuations of luminance of individual discharge tubes 101 as shown in FIG. 9 can be eliminated.

In the configuration shown in FIG. 1, a conductive member 105 of aluminum tape of 3 mm in width is disposed at a distance of 25 cm from the internal electrode of each discharge tube 101 (position of 70% of overall length of discharge tube 101 as seen from the internal electrode end), connecting electrically the outer surface of all discharge tubes 101. The conductive member 105 is connected electrically and physically to the external electrode 103 at a connection point 106 at the end of the external electrode 103. Hence, the points contacting with the conductive member 105 on the outer surface of all discharge tubes 101 are equal in potential (nearly equal in grounding potential) through the conductive member 105.

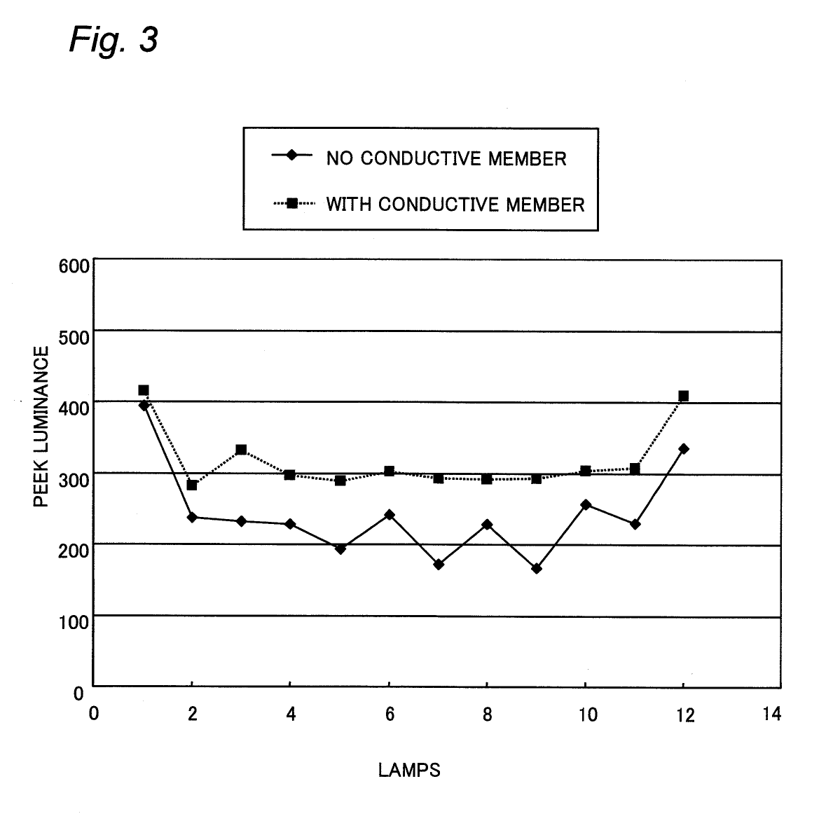

FIG. 3 is a diagram explaining the effects of disposing the conductive member 105. FIG. 3 shows the measured luminance of each discharge tube 101 at position of about 30 cm from the side of internal electrode 102 of the discharge tube 101 when the discharge tube 101 is lighted up at applied voltage of 2.0 kV. From FIG. 3, it is clearly understood that the bright lamp and the dark lamp appear alternately without the conductive member 105, while the luminance is almost uniform with the conductive member 105.

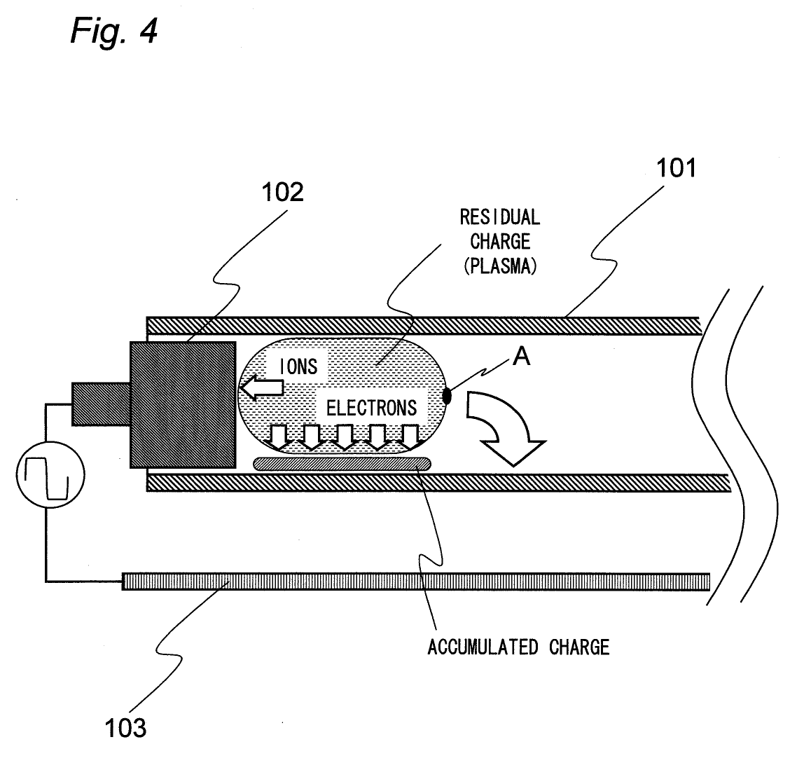

The reason why fluctuation of luminance of the discharge tube 101 is eliminated by disposing the conductive member 105 is discussed below. Referring now to FIG. 4, the development of dielectric barrier discharge between the internal electrode 102 and the external electrode 103 is briefly explained. In FIG. 4, as an example, the state of inversion of potential of the internal electrode 102 from positive to negative is shown. However the same discussion seems to hold true if the potential is inverted in reverse polarity.

When the high applied voltage of the internal electrode 102 becomes high to cause the dielectric breakdown to occur, discharge is started near the internal electrode 102 which has the highest electric field intensity. As the discharge is started, the plasma is generated inside the discharge tube 101. Positive and negative charges in the plasma (mainly ions and electrons) drift to the internal electrode 102 or the external electrode 103 in the space in the discharge tube 101 by the electric field between the internal electrode 102 and external electrode 103, generating a lamp current flow. The electric charges (electrons) drifting to the external electrode 103 are accumulated in the tube wall of the discharge tube 101 because the tube wall of the discharge tube 101 which is insulator acts as a charge barrier. The accumulated charges neutralize the electric field between the electrodes by the electric field generated from the accumulated charges. As a result, the discharge in the discharge gas cannot be maintained in time near the internal electrode 102 where the discharge is first started and then disappears.

As a result, the charges (referred to as “residual charges”) remaining in the space without drifting in the plasma generated by the initial discharge are present in a state similar to the so-called pulse after-glow plasma. The plasma behaves like a conductor having a finite electric resistance. Thus the leading end portion A of the residual charges becomes a pseudo internal electrode having a potential lower than the potential of the internal electrode 102 by the voltage drop across the residual charges. On the other hand, since in the region ahead of the leading end portion A of the residual charges, charges are not accumulated in the tube wall of the discharge tube 102, the discharge can be started by the electric field caused by potential difference between the leading end portion A of the residual charges and the external electrode 103. Therefore, until the potential in the leading end portion A of the residual charges becomes lower than a discharge start voltage by the voltage drop in the plasma, or until the leading end portion A of the residual charges reach the end portion of the discharge tube 102, the discharge develops while repeating the above process in every small distance in the longitudinal direction, extending the plasma of the residual charges. Further, as the voltage drop in the plasma is smaller and the potential in the leading end portion A of the plasma is higher, the excitation efficiency of xenon is higher, and therefore the luminance may be expected to be higher.

The discussion is made below for the case in which a plurality of discharge tubes 101 are disposed closely in parallel as shown in FIG. 1. What contributes to ionization of plasma or excitation of xenon is the potential difference between the potential of the plasma leading end portion A and the potential of the external electrode 103. However, when closely adjacent discharge tubes are lighted simultaneously, since the plasma in the adjacent discharge tube is also high in potential, it would be affected by the electric field. That is, from the view points of the plasma in a certain discharge tube, the surrounding potential is relatively high due to the effect of the electric field generated by the adjacent discharge tube, and the effective potential difference between the leading end portion A of the residual charges and the external electrode 103 is lower as compared with the state in which a single discharge tube 101 is provided to the external electrode 103. Therefore, it is estimated that the luminance is likely to be much lower particularly at the portion far from the internal electrode 102 in which the potential of the plasma leading end portion is lowered due to voltage drop in the plasma when the discharge continues to develop.

Further, when a certain discharge tube suffers such an effect, the effective electric field intensity by which the plasma in the discharge tube is influenced drops. Thus, the luminance is lowered, and the degree of ionization of plasma becomes lower, and therefore the voltage drop in the plasma increases. As a result, the plasma potential is lower as becoming remoter from the internal electrode 102. In other words, the electric field intensity formed in the surrounding by the discharge tube 101 having such effect is lower, and hence the effect of this discharge tube 101 on the discharge tubes at both sides is smaller. As a result, it is estimated that a discharge tube with high luminance and a discharge tube with low luminance appear alternately.

The problem which provides motivation of the invention does not exist if the discharge tubes 101 are present alone near the external electrode 103. The problem occurs only when a plurality of discharge tubes 101 are juxtaposed and lighted to a common external electrode 103.

To this problem, the conductive member 105 is provided in the first embodiment of the invention. With this, the potential of the outer surface of the portion of the discharge tube 101 contacting with the conductive member 105 is forced to be equal to the grounding potential, generating the effect of making the plasma potential in the discharge tube 101 uniform, even if there is a gap between the discharge tube 101 and the external electrode 103. Hence it is estimated that fluctuations of luminance of mutual discharge tubes are reduced.

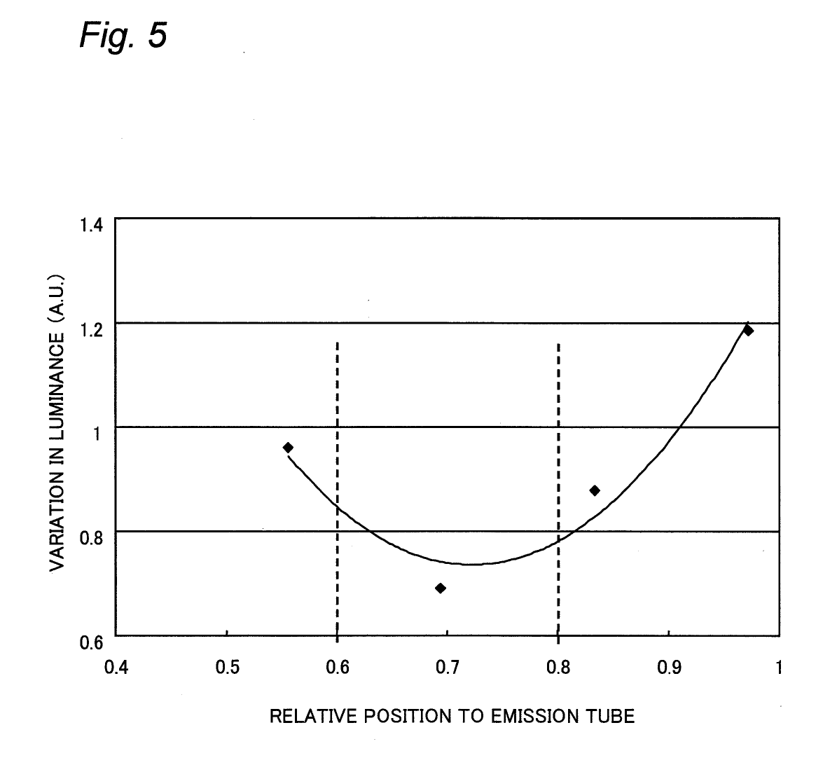

An optimum position for disposing the conductive member 105 is discussed. FIG. 5 shows results of experiment to investigate effects by varying the distance of the conductive member 105 from the internal electrode 102 on the discharge tube 101. The degree of the effect is evaluated by the standard deviation (variance) of luminance of twelve discharge tubes 101. The axis of abscissas in FIG. 5 denotes the relative position to the overall length of the discharge tube 101, which is obtained by dividing the distance from the internal electrode 102 to the conductive member 105 by the overall length of the discharge tube 101. The axis of ordinates represents the standard deviation of luminance of twelve discharge tubes 101, in a relative value as compared with 1 when the conductive member 105 is not used. From this experiment it is seen that there is almost no effect near the center of the discharge tube 101 (that is, at position of 50%), however there is a greater effect at the far side from the center of the internal electrode 102 and the effect is maximum at a position of about 70% of the overall length. The effect is smaller again at the side closer to the end portion. This is because the plasma potential is sufficiently high at the side closer to the internal electrode 102 compared to the central portion, and the effect of the adjacent discharge tube is relatively small, and hence the effect of the conductive member 105 is smaller. To the contrary, at the site sufficiently far from the internal electrode 102, the difference in internal plasma potentials between mutual discharge tubes is too large, and hence the effect of the conductive member 105 seems to be insufficient. Therefore, a range of effective positions of the conductive member 105 exists, and it is preferred to dispose the conductive member 105 approximately in a range of 60% to 80% of the overall length of the discharge tube.

In the first embodiment, the overall length of discharge tube 101 is 37 cm. However, if the length is different, the same discussion holds true. From the above discussion of discharge development, there is correlation between the length of the discharge tube 101 and a sufficient applied voltage, and thus the range of effective disposing position of the conductive member 105 seems to have generality. The same may be considered for the diameter of the discharge tube 101.

The conductive member 105 functions to regulate the potential, and large current does not flow in the conductive member 105 itself. Accordingly, the conductive member 105 does not require large area. In the first embodiment, an aluminum tape of 5 mm in width is used, but the width is not limited to this. A thinner wire conductor may be used. The conductor is also not limited to a metal material, and ITO or other transparent conductive material may be used.

The conductive member 105 may be coupled to the connection point 106 at the end of the external electrode 103 via a high resistance, for example, a resistance of 1 M□ or more. In this manner, the current flowing in the conductive member 105 may be much smaller, and the power consumption can be reduced.

### Second Embodiment

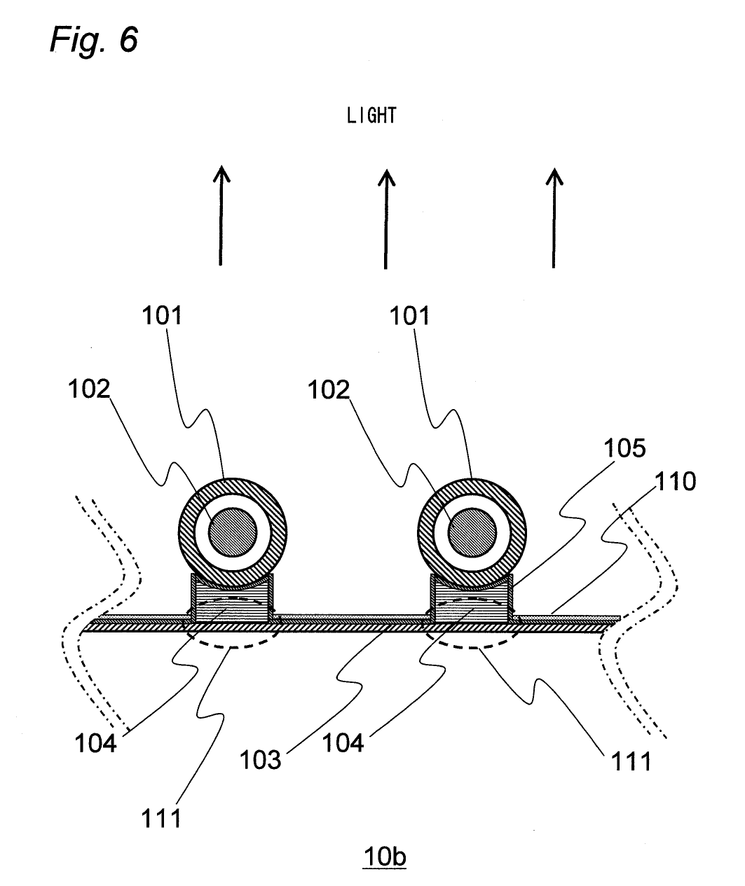

FIG. 6 is a diagram showing other configuration of liquid crystal display backlight device using rare gas fluorescent lamps of the invention.

In the configuration of the liquid crystal display backlight device 10b shown in FIG. 6, a conductive member 105 is inserted between a resin-made spacer 104 to maintain the discharge tube 101 at a specified distance from the external electrode 103 (about 5 mm in the preferred embodiment) and a discharge tube 101, so that the discharge tubes 101 may conduct each other electrically. The conductive member 105 is disposed at a position of 70% of the overall length of the discharge tube 101, as seen from the internal electrode 102. The conductive member 105 is grounded by contacting electrically and directly with the external electrode 103 at the outside of the spacer 104. For physical fixing between the spacer 104 and the conductive member 105, and between the conductive member 105 and the discharge tube 101, an adhesive agent having enough heat resistance capable of avoiding thermal deformation during lighting of the discharge tube 101 is used. The shape of the spacer 104 may be also designed to support the discharge tube 101 physically with the conductive member 105 interposed between the spacer 104 and the discharge tube 101. Such configuration can prevent the light emitted from the discharge tube 101 from being blocked by the conductive member 105 to form a shadow. Further, a diffusion optical member 110 is provided on the external electrode 103 and conductive member 105, of which surface may be a plane with nearly perfect diffusion to visible light. An opening 111 is provided in the diffusion optical member 110, through which the spacer 104 and conductive member 105 project to support the discharge tube 101. As a result, evident appearance of shadow of the discharge tube 101 on the liquid crystal display can be avoided. The conductive member 105 may be disposed on the opposite side of the discharge tube 101 to the surface of the discharge tube on the external electrode 103 side.

### Third Embodiment

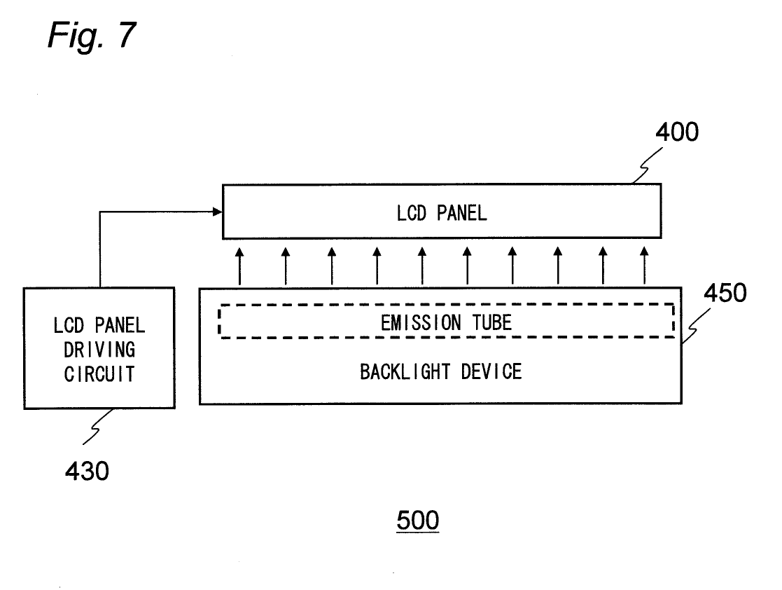

FIG. 7 is a diagram showing a configuration of liquid crystal display device using the liquid crystal display backlight device in the foregoing embodiments. A liquid crystal display device 500 includes a liquid crystal display (LCD) panel 400, a liquid crystal display panel driving circuit 430 for driving the liquid crystal display panel according to an input image signal, and a backlight device 450 for illuminating the liquid crystal display panel 400. The backlight device 450 is, for example, the device 10 or 10b shown in the first or second embodiment. In the liquid crystal display device having such configuration, the backlight device 450 is capable of reducing fluctuations of luminance of mutual discharge tubes, and illuminating the liquid crystal display panel 400 with a backlight of a uniform luminance distribution. Hence, an image display of high image quality free from uneven luminance is realized in the entire screen.

### INDUSTRIAL APPLICABILITY

The rare gas fluorescent lamp of the invention realizes a fluorescent lamp excellent in uniformity of luminance at high efficiency without using mercury, and is useful for liquid crystal display backlight, especially liquid crystal display backlight for wide-screen television.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present application is related to the Japanese Patent Application No. 2006-310267, filed on Nov. 16, 2006, the contents of which are incorporated herein by reference.

1. A light source device comprising:
a plurality of juxtaposed discharge tubes, each of which includes an internal electrode at least at one end, is made of transmissive material, has a phosphor layer formed at the inner side of the discharge tube, and is filled with a discharge gas containing xenon;
an external electrode which is conductive and flat-shaped, is spaced from the plurality of discharge tubes by a specific distance, and is connected electrically to the grounding potential; and
a conductive member electrically configured to connect the outer surface of all of the plurality of discharge tubes to the external electrode.

2. The light source device according to claim 1, wherein the conductive member is a band-shaped metal foil disposed orthogonally to the discharge tube.

3. The light source device according to claim 1, wherein the conductive member is disposed at a distance more than half of the overall length of the discharge tube from the internal electrode of the discharge tubes.

4. The light source device according to claim 3, wherein the conductive member is disposed at a distance equal to a length more than 60 percent to less than 80 percent of the overall length of the discharge tube from the internal electrode of the discharge tubes.

5. The light source device according to claim 1, wherein the conductive member is disposed between the discharge tube and the external electrode.

6. The light source device according to claim 1, wherein the conductive member is disposed on the opposite side of the discharge tube to the surface of the discharge tube on the external electrode side.

7. A liquid crystal display device comprising:
a liquid crystal display panel; and
a backlight device for illuminating the liquid crystal display panel, including the light source device according to claim 1.

8. The light source device according to claim 2, wherein the conductive member is disposed at a distance more than half of the overall length of the discharge tube from the internal electrode of the discharge tubes.

9. The light source device according to claim 8, wherein the conductive member is disposed at a distance equal to a length more than 60 percent to less than 80 percent of the overall length of the discharge tube from the internal electrode of the discharge tubes.

10. The light source device according to claim 2, wherein the conductive member is disposed between the discharge tube and the external electrode.

11. The light source device according to claim 2, wherein the conductive member is disposed on the opposite side of the discharge tube to the surface of the discharge tube on the external electrode side.
